(19) United States
(12) Patent Application Publication
(10) Pub. No.: US 2010/0082948 A1
(43) Pub. Date: Apr. 1, 2010

(54) CHANNEL COMMAND WORD PRE-FETCHING APPARATUS

(75) Inventors: Tsukasa Matsuda, Kawasaki (JP); Hideki Yamanaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/493,951

(22) Filed: Jun. 29, 2009

(30) Foreign Application Priority Data
Sep. 26, 2008 (JP) 2008-247369

(51) Int. Cl. G06F 9/30; G06F 3/00

(52) U.S. Cl. 712/207; 710/5; 712/E09.028

(57) ABSTRACT

In a CCW fetching section, for each input/output device being a control objective, a result prediction table in which prediction values of status values to be returned from an input/output device as execution results of CCW commands, is referred to. Then, based on the prediction values, commands being pre-fetching objectives are pre-fetched from a CCW program stored in a memory, and transmitted to a CCW executing section. On the other hand, in the CCW executing section, the pre-fetched commands are sequentially executed, and the actual status values as the execution results are received from the input/output device. Then, when the received actual status values are not same as the predicted status values, success or failure in prediction is notified to the CCW fetching section, and also, the result prediction table is updated in the CCW fetching section.

### CROSS-REFERENCE TO RELATED APPLICATION

This application is based upon and claims the benefit of priority of the prior Japanese Patent Application No. 2008-247369, filed on Sep. 26, 2008, the entire contents of which are incorporated herein by reference.

### FIELD

The embodiment discusses herein is directed to a technology for pre-fetching channel command words for controlling an input/output device.

### BACKGROUND

Generally, in a computer, there has been used a channel for controlling information transfer to/from a main storage device and an input/output device, in order to promote an input/output operation to/from the input/output device independently from a CPU. The channel fetches CCWs (Channel Command Words) each of which is described with a control instruction to the input/output device from a memory. Each CCW is composed of one word of 8 bytes and contains commands for controlling the input/output device, various types of control flags such as a CC (Chain-Command) flag and the like, and so on. Then, the channel executes the commands of the fetched CCWs and instructs operations of the input/output device.

Further, in executing the command of CCWs, the command to be next processed is changed according to a status value returned from the input/output device as an execution result of each command. As a specific example, when a status value of execution result of a certain command is “0C”, a command advanced from the certain command by one word is executed among the commands of the CCWs. On the other hand, when the status value is “4C”, a command advanced from the certain command by two words is executed. Further, in the commands, other than those for performing the input/output operation, there is a “TIC” or the like as a branch command for executing an arbitrary one word command.

Here, in a computer or the like implemented with a multiprocessor, in order to efficiently perform parallel processing, a CCW fetching section that fetches the CCWs from the memory and a CCW executing section that executes the commands of the fetched CCWs may be separately configured. In such a configuration, in order to reduce communications traffic between the CCW fetching section and the CCW executing section, pre-fetching of commands is performed. The pre-fetching is for fetching a plurality of commands in the CCW fetching section to collectively transmit the fetched commands to the CCW executing section, and also, for sequentially executing the received plurality of commands word by word in the CCW executing section.

Then, in this pre-fetching, before a command is actually executed and the status value as the command execution result is returned from the input/output device, it is necessary to fetch a next command to be processed. Therefore, on the assumption that a specific status value is necessarily returned for all commands, the commands are sequentially pre-fetched. However, in practice, the status value different from the assumed status value may be returned from the input/output device, and accordingly, the pre-fetched command may not match with the next command to be processed according to the status value actually returned from the input/output device. In the above specific example, even if the commands are sequentially fetched on the assumption that the status values returned from the input/output device as the execution results of all commands are all “0C”, practically, the status value returned from the input/output device is not necessarily “0C”, and “4C” may be returned. Further, for example in the case where the next pre-fetched command is “TIC” on the assumption that the status values returned from the input/output device as the execution results are all “0C”, for example if “TIC” is for executing a previous command, an infinite loop may be caused. Therefore, there has been proposed a technology for disposing a pre-fetching control bit in the CCW to control the commands to be pre-fetched according to types of input/output devices and commands (e.g., Japanese Laid-open Patent Publication No. 63-245542).

However, even in the case where the commands to be pre-fetched are controlled according to the types of input/output devices and commands, it is still necessary to pre-fetch the commands, before the commands are actually executed and the status values of the execution results are obtained. Therefore, it is necessary to control the commands to be pre-fetched, after the status values as the command execution results are predicted for each of types of input/output devices and commands and the predicted status values are assumed to be returned from the input/output device. However, even if the types of the input/output devices and commands are same, the same status value is not always returned as a result that the commands are actually executed. Further, in practice, another status value rather than the predicted status value may be frequently returned from the input/output device. In such a case, due to a difference between the status value of the pre-fetched command and the actual status value from the input/output device, mismatch between the pre-fetched command and the command to be next executed frequently occurs.

### SUMMARY

According to an aspect of the embodiment, a table for each input/output device being a control objective of a CCW program, in which parameters indicating probability of being returned from the input/output device are set for each status value to be returned from the control objective input/output device as an execution result of each command contained in the CCW program, is referred to. Then, a status value as each command execution result (predicted status value) is predicted based on the parameters, and a command being a pre-fetching objective is determined based on the predicted status value as each command execution result. Further, all of commands being the pre-fetching objectives are pre-fetched from the CCW program stored in a memory.

Further, when the pre-fetching of all of the commands being the pre-fetching objectives is completed, the pre-fetched commands are sequentially executed, and each time when the pre-fetched command is executed, the status value as the command execution result (actual status value) is received from the input/output device being the control objective. Then, when the actual status value is received from the input/output device, it is judged whether or not the received actual status value is the same as the predicted status value. As a result, when the received actual status value is different from the predicted status value, a value of the parameter, set in the table, corresponding to the received actual status value, is updated to be increased relatively to a value of the parameter, set in the table, corresponding to the predicted status value.

The objects and advantages of the invention will be realized and attained by means of the elements and combinations particularly pointed out in the claims.

It is to be understood that both the foregoing general description and the following detailed description are exemplary and explanatory only and are not restrictive of the invention, as claimed.

### BRIEF DESCRIPTION OF DRAWINGS

FIG. 1 is an entire configuration view of one example of an apparatus realizing a CCW pre-fetching mechanism;

FIG. 2 is an explanatory view of result prediction tables;

FIG. 3 is an explanatory view of a CPA list;

FIG. 4 is an explanatory view of an input/output device table;

FIG. 5 is an explanatory view of a COB;

FIG. 6 is an explanatory view of a CIB;

FIG. 7 is a flowchart of a process executed by a CCW fetching section;

FIG. 8 is a flowchart of the process executed by the CCW fetching section, continued from the flowchart of FIG. 7;

FIG. 9 is a flowchart of a pre-fetching judging process;

FIG. 10 is a flowchart of a device discriminating process;

FIG. 11 is a flowchart of a result predicting process;

FIG. 12 is a flowchart of a result learning process;

FIG. 13 is a flowchart of a process executed by a CCW executing section;

FIG. 14 is a flowchart of a result comparing process;

FIG. 15 is a flowchart of a result notifying process;

FIG. 16 is an explanatory view of the result prediction table before processing, in a specific example in which pre-fetching prediction succeeds;

FIG. 17 is an explanatory view of a process sequence, in the specific example in which the pre-fetching prediction succeeds;

FIG. 18 is an explanatory view of the result prediction table after processing, in the specific example in which the pre-fetching prediction succeeds;

FIG. 19 is an explanatory view of the result prediction table before processing, in a specific example in which the pre-fetching prediction fails;

FIG. 20 is an explanatory view of a process sequence, in the specific example in which the pre-fetching prediction fails;

FIG. 21 is an explanatory view of the result prediction table after processing, in the specific example in which the pre-fetching prediction fails; and

FIG. 22 is an explanatory view of a process sequence for when pre-fetching is not performed.

### DESCRIPTION OF EMBODIMENTS

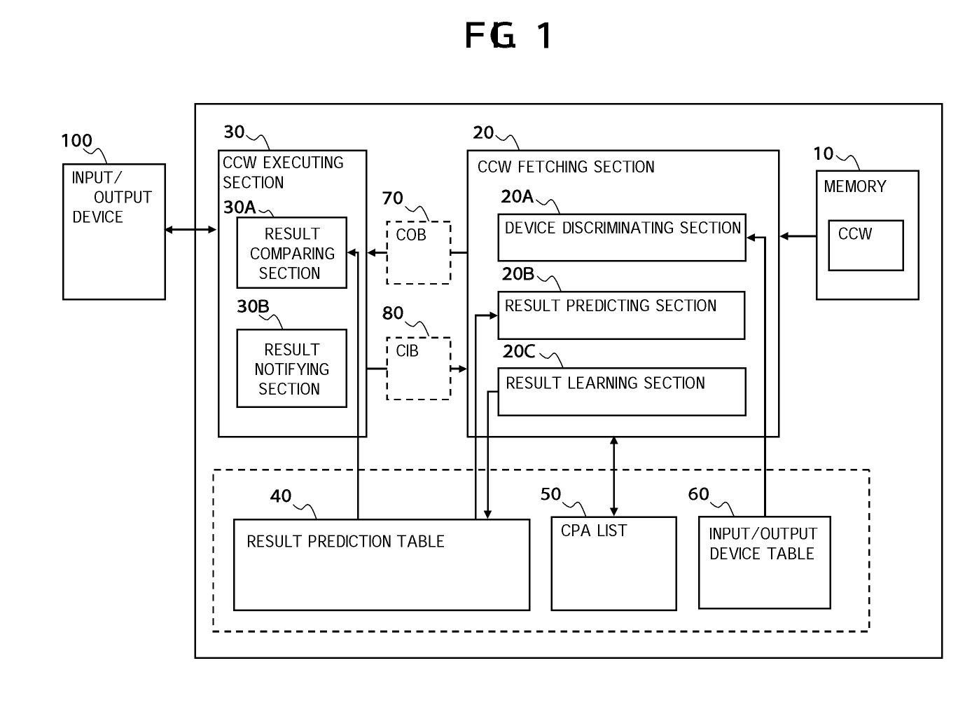

FIG. 1 illustrates an entire configuration of one example of an apparatus realizing a CCW pre-fetching mechanism. Functions of respective constitutional elements of this apparatus are achieved by loading a CCW pre-fetching program into a computer provided with at least a CPU (Central Processing Unit) and storage means. Then, as illustrated in FIG. 1, the present apparatus includes a memory 10 in which a CCW program is stored, a CCW fetching section 20 and a CCW executing section 30, and further, is connected to an input/output device 100. Various devices for performing transmission/reception of data to/from the computer, such as, an external storage device such as a magnetic disk, a printer and the like, correspond to the input/output device 100. Further, the present apparatus includes result prediction tables 40, a CPA (Channel Program Address) list 50 and an input/output device table 60. Furthermore, in order to transmit data from the CCW fetching section 20 to the CCW executing section 30, a data structure (domain) of a COB (Channel Operation Buffer) 70 is used. On the other hand, in order to transmit data from the CCW executing section 30 to the CCW fetching section 20, a data structure of a CIB (Channel Interruption Buffer) 80 is used. In FIG. 1, although only one input/output device 100 is connected, two or more input/output devices may be connected.

Next, there will be described the respective constitutional elements of the present apparatus.

As described in the above, the CCW program is stored in the memory 10.

The CCW fetching section 20, at least, fetches out commands of CCWs from the CCW program stored in the memory 10, and sets the fetched commands of the CCWs in the COB 70 to transmit the COB 70 to the CCW executing section 30. Here, the CCW fetching section 20 provides at least functions of a pre-fetching step and pre-fetching means. Further, the CCW fetching section 20 includes a device discriminating section 20A, a result predicting section 20B and a result learning section 20C.

The device discriminating section 20A refers to the input/output device table 60, to acquire an input/output device name based on a machine number of the input/output device 100 being a control objective, which is notified from a user application or the like (not shown in the figure).

The result predicting section 20B refers to the table corresponding to the input/output device 100 among the result prediction tables 40, to acquire a prediction value of a status value as each command execution result, as a predicted status value. Here, the result predicting section 20B provides functions of a predicting step and predicting means.

The result learning section 20C updates the table corresponding to the input/output device 100 among the result prediction tables 40, based on the execution result which is contained in the CIB 80 received from the CCW executing section 30. Here, the result learning section 20C provides functions of a first updating step, first updating means, a second updating step and a third updating step.

The CCW executing section 30, at least, executes the command fetched by the CCW fetching section 20 to control the input/output device 100, and also, receives the actual status value returned from the input/output device 100. Here, the CCW executing section 30 provides at least functions of an executing step, executing means, a receiving step and receiving means. Further, the CCW executing section 30 includes a result comparing section 30A and a result notifying section 30B.

The result comparing section 30A compares the prediction value of the status value in pre-fetching with the status value actually returned from the input/output device as the command execution result. Then, the result comparing section 30A judges that the prediction in the pre-fetching succeeded if both of the prediction value and the actual status value are coincident with each other, while judging that the prediction in the pre-fetching failed if both of the prediction value and the actual status value are different from each other. Here, the result comparing section 30A provides functions of a judging step and judging means.

The result notifying section 30B sets information containing the result as to whether the pre-fetching succeeded or failed in the CIB 80 to transmit the CIB 80 to the CCW fetching section 20.

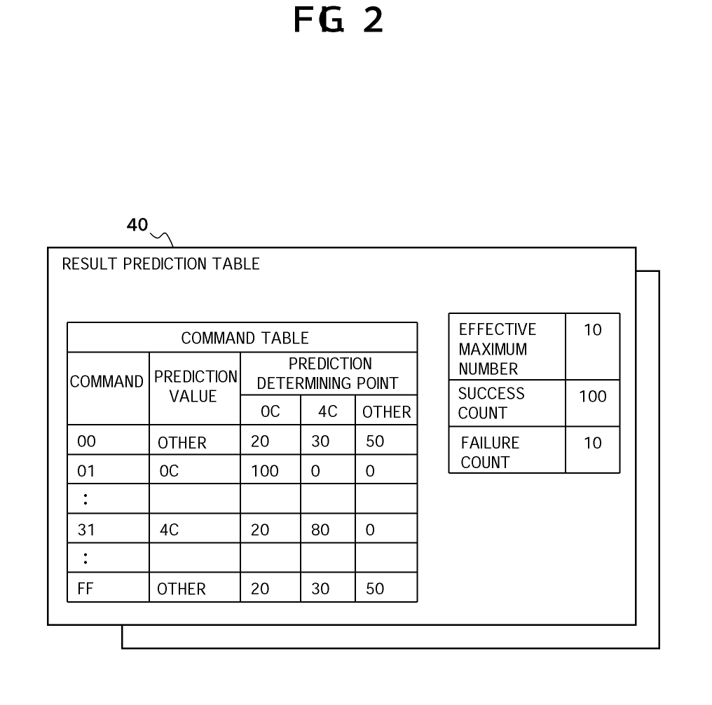

In the result prediction tables 40, the prediction value of the status value of each command is set for each input/output device. Then, as illustrated in FIG. 2, each of the result prediction tables 40 includes, as a command table, commands and the prediction values of the status values (the candidate status values) of the commands, prediction determining points (parameters) indicating probability that each status value is returned from the input/output device 100. To the prediction value of each command status value, the status value of which prediction determining point is highest is set, and the prediction determining points are set so that the sum of the points of the status values becomes 100 for each command. Further, each of the result prediction tables 40 is registered corresponding to each connected input/output device 100. Furthermore, the result prediction tables 40 includes therein, for each input/output device 100, an effective maximum number indicating a maximum number of commands to be pre-fetched, and a success count and a failure count of prediction in the pre-fetching.

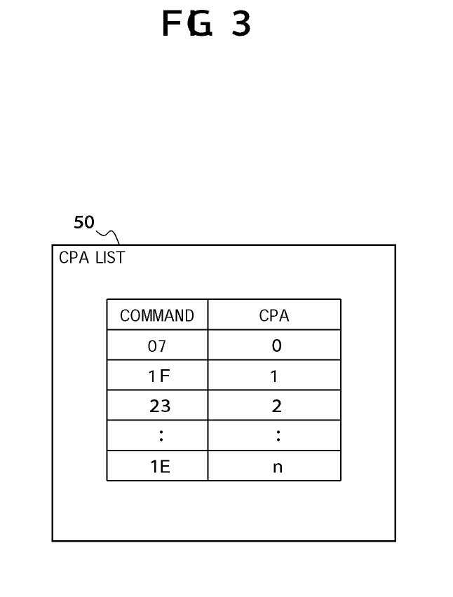

The CPA list 50 holding therein addresses of the pre-fetched commands is to be used when the prediction in the pre-fetching failed, and as illustrated in FIG. 3, includes the commands and the command addresses.

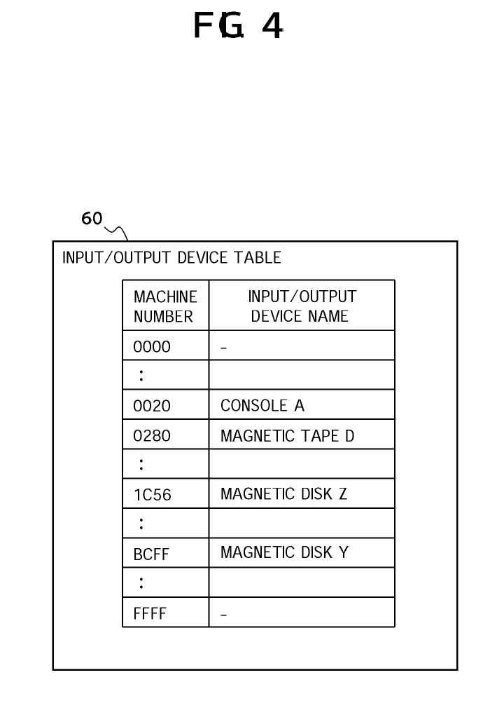

The input/output device table 60 is a matching table of the machine numbers of the connected input/output devices with the names thereof, and as illustrated in FIG. 4, includes the machine numbers of the input/output devices and the input/output device names.

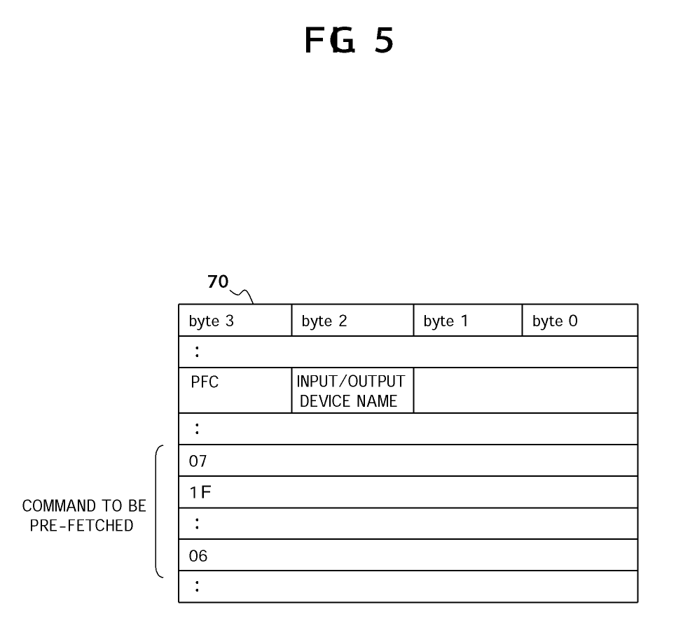

As illustrated in FIG. 5, the COB 70 includes a PFC (Prefetch Count) in which the number of commands pre-fetched by the CCW fetching section 20 is stored. If a value of the PFC is “0”, the pre-fetching is invalid, whereas if the value is “1 or more”, the pre-fetching is valid and the value indicates the number of pre-fetched commands (except for the leading command). Further, the pre-fetched commands are stored in the COB 70 in the order of pre-fetching. Furthermore, the input/output device names of the input/output devices being the control objectives are further stored in the COB 70.

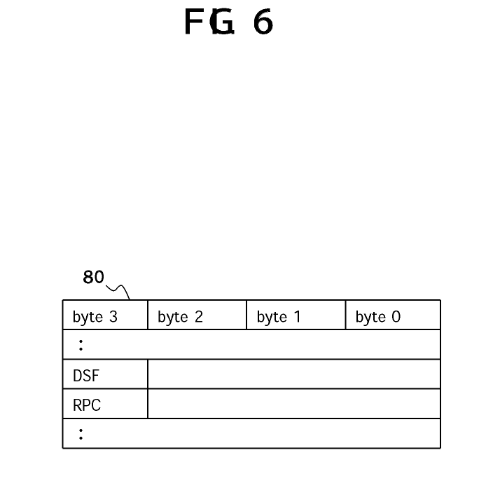

As illustrated in FIG. 6, the CIB 80 includes a DSF (Device Status Field) in which the status values generated by the input/output devices as the command execution results are stored. Further, the CIB 80 includes a RPC (Residual Prefetch Count) to be used for judging whether the prediction in the pre-fetching succeeded or failed. If the value of the RPC is “0”, it is indicated that the prediction succeeded or the pre-fetching itself is not performed. If the value of the RPC is “1 or more”, it is indicated that the prediction failed, and the value indicates the number of commands for which pre-fetching failed and the number of commands which are not executed due to prediction failure.

### [Description of Content of Process in the Present Apparatus]

Next, there will be described a content of process in the present apparatus, using flowcharts.

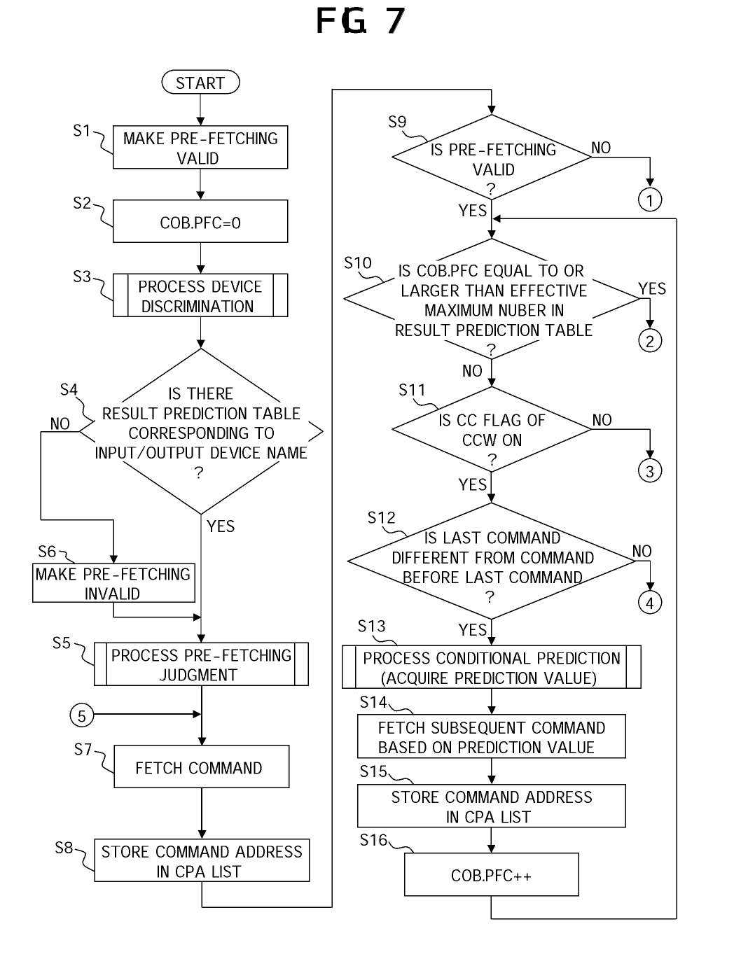

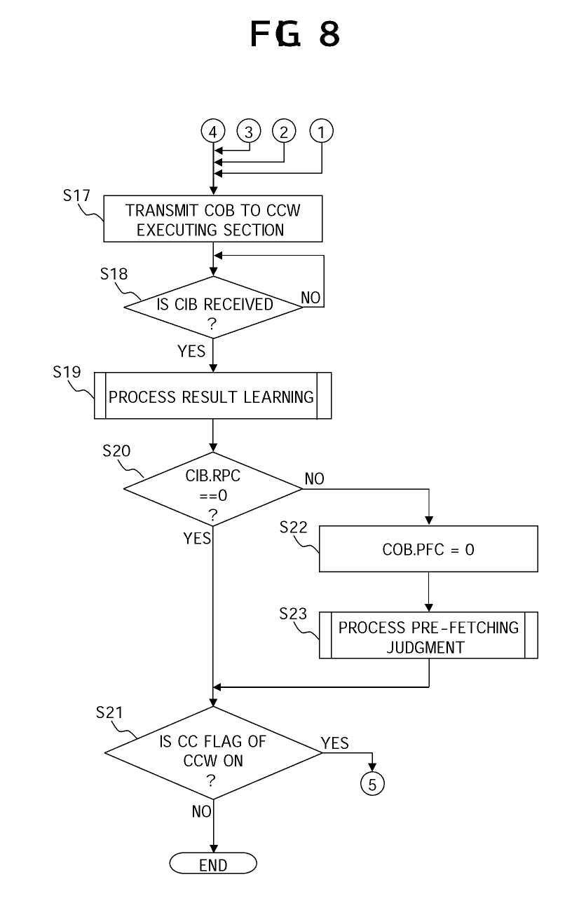

FIG. 7 and FIG. 8 indicate a process in the CCW fetching section 20.

In step 1 (to be abbreviated as Si in the figure, and the same rule will be applied to subsequent steps), the pre-fetching is made valid. To be specific, a value indicating validity is set in a variable to be used for judging whether or not the pre-fetching is to be performed (prefetch_sts=valid).

In step 2, 0 is set to the PFC of the COB 70.

In step 3, a sub-routine of a device discriminating process executed in the device discriminating section 20A is executed.

In step 4, it is judged whether or not the table corresponding to the input/output device name discriminated by the device discriminating process is set in the result prediction tables 40. If the table corresponding to the input/output device name is set in the result prediction tables 40 (YES), the routine proceeds to step 5, whereas if the table corresponding to the input/output device name is set in the result prediction tables 40 (NO), the routine proceeds to step 6.

In step 5, a sub-routine of a pre-fetching judging process is executed.

In step 6, the pre-fetching is made invalid (prefetch_sts=invalid).

In step 7, the command of the CCW is fetched by one word.

In step 8, the fetched command and the address thereof are set in the CPA list.

In step 9, it is judged whether or not the pre-fetching is valid (prefetch_sts==valid). If the pre-fetching is valid (YES), the routine proceeds to step 10, whereas if the pre-fetching is invalid (NO), the routine proceeds to step 17.

In step 10, it is judged whether or not the PFC of the COB 70 is equal to or larger than the effective maximum number corresponding to the input/output device name being the control objective, which is set in the result prediction tables 40. If the PFC is equal to or larger than the effective maximum number (YES), the routine proceeds to step 17, whereas if the PFC is smaller than the effective maximum number (NO), the routine proceeds to step 11.

In step 11, it is judged whether or not a CC flag of the CCW is on. If the CC flag is on (YES), the routine proceeds to step 12, whereas if the CC flag is off (NO), the routine proceeds to step 17.

In step 12, it is judged whether or not the address of the lastly fetched command is different from the address of the command fetched just before the lastly fetched command. If both of the addresses are different from each other (YES), the routine proceeds to step 13, whereas if both of the addresses are same (NO), the routine proceeds to step 17.

In step 13, a sub-routine of a result prediction process executed in the result predicting section 20B is executed.

In step 14, the command is further fetched by one word based on the prediction value of the status value as the execution result acquired by the result predicting process. For example, if the prediction value is “0C”, the command advanced by one word is fetched, and if the prediction value is “4C”, the command advanced by two words is fetched.

In step 15, the fetched command and the address thereof are set in the CPA list.

In step 16, the PFC of the COB 70 is incremented.

In step 17, the COB 70 is transmitted to the CCW executing section 30. At the time, the COB 70 is transmitted after the fetched command is set therein.

In step 18, it is judged whether or not the CIB 80 is received from the CCW executing section 30C. If the CIB 80 is received (YES), the routine proceeds to step 19, whereas if the CIB 80 is not received (NO), the routine stands by.

In step 19, a sub-routine of a result learning process executed in the result learning section 20C is executed.

In step 20, it is judged whether or not the RPC of the CIB 80 is 0. If the RPC is 0 (YES), the routine proceeds to step 21, whereas if the RPC is not 0 (NO), the routine proceeds to step 22.

In step 21, it is judged whether or not the CC flag of the CCW is on. If the CC flag is on (YES), the routine returns to step 7, whereas if the CC flag is not on (NO), the routine is terminated.

In step 22, 0 is set to the PFC of the COB 70.

In step 23, the sub-routine of the pre-fetching judging process is executed.

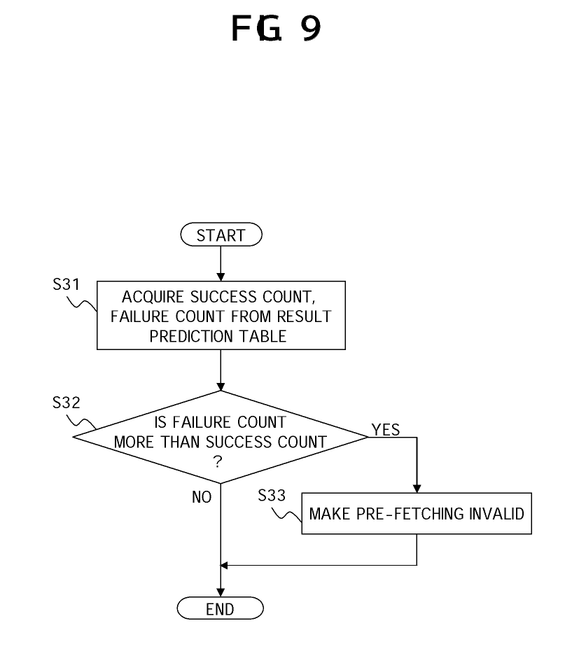

FIG. 9 illustrates a content of the sub-routine of the pre-fetching judging process.

In step 31, the success count and the failure count in the table corresponding to the control objective input/output device among the result prediction tables 40, are acquired.

In step 32, it is judged whether or not the failure count is more than the success count. If the failure count is more than the success count (YES), the routine proceeds to step 33, whereas if the failure count is equal to or less than the success count (NO), the routine is terminated.

In step 33, a pre-fetching flag is made invalid.

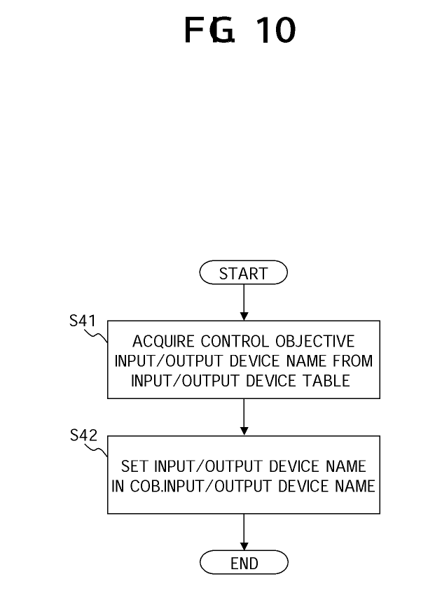

FIG. 10 illustrates a content of the sub-routine of the device discriminating process executed in the device discriminating section 20A.

In step 41, the input/output device table 60 is referred to, and the input/output device name is acquired based on the machine number of the control objective input/output device.

In step 42, the acquired input/output device name is set as the input/output device name of the COB 70.

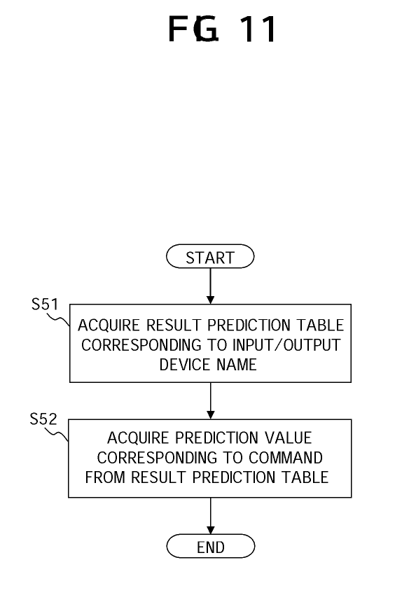

FIG. 11 illustrates a content of the sub-routine of the result predicting process executed in the result predicting section 20B.

In step 51, the result prediction tables 40 are referred to, and the table corresponding to the input/output device name is acquired.

In step 52, the prediction value corresponding to the lastly fetched command is acquired from the acquired result prediction table 40, and returned.

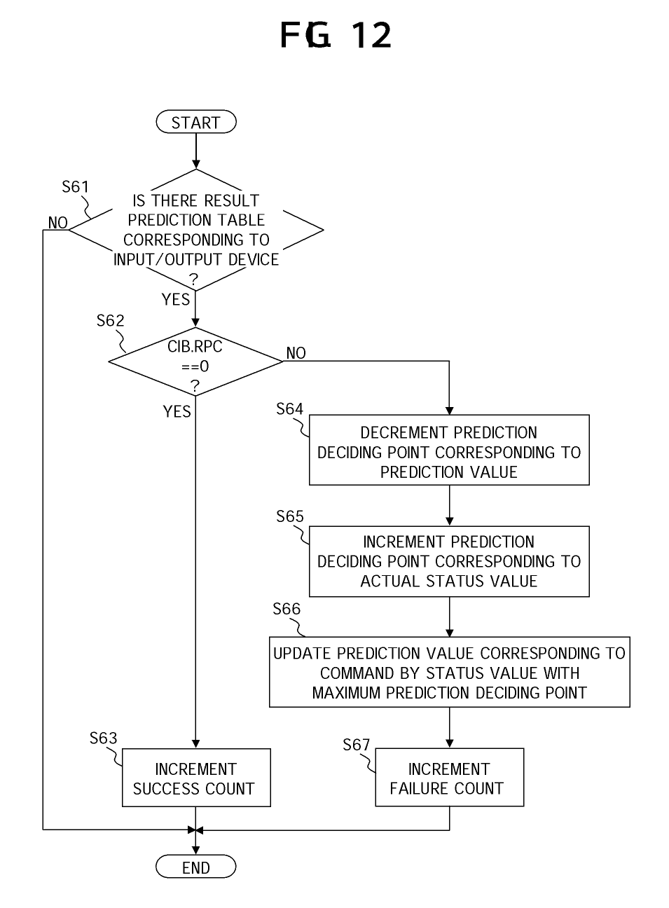

FIG. 12 illustrates a content of the sub-routine of the result learning process executed in the result learning section 20C.

In step 61, it is judged whether or not the table corresponding to the control objective input/output device is set in the result prediction tables 40. If the table corresponding to the input/output device is set (YES), the routine proceeds to step 62, whereas if the table corresponding to the input/output device is not set (NO), the routine is terminated. Hereafter, in this process, it is assumed that the table corresponding to the control objective input/output device among the result prediction tables 40 is a processing objective.

In step 62, it is judged whether or not the RPC of the CIB 80 is 0. If the RPC is 0 (YES), the routine proceeds to step 63, whereas if the RPC is not 0 (NO), the routine proceeds to step 64.

In step 63, the success count in the result prediction table 40 is incremented.

In step 64, in the result prediction table 40, the prediction determining point corresponding to the status value set as the prediction value of the command lastly executed by the CCW executing section 30 is decremented. The lastly executed command can be specified based on the value of the RPC.

In step 65, the prediction determining point corresponding to the status value actually set to the DSF of the CIB 80 is incremented. By the process in steps 64 and 65, the prediction determining point is shifted by one point from the prediction determining point corresponding to the status value set as the prediction value to the prediction determining point corresponding to the status value actually set to the DSF of the CIB 80.

In step 66, if the prediction value of the command lastly executed by the CCW executing section 30 is different from the status value of which prediction determining point is maximum in the result prediction table 40, the prediction value is updated by the status value of which prediction determining point is maximum. When there is a plurality of status values which has the same prediction determining points, the status value of which prediction determining point is lastly incremented may be set as the prediction value.

In step 67, the failure counts in the result prediction table 40 is incremented.

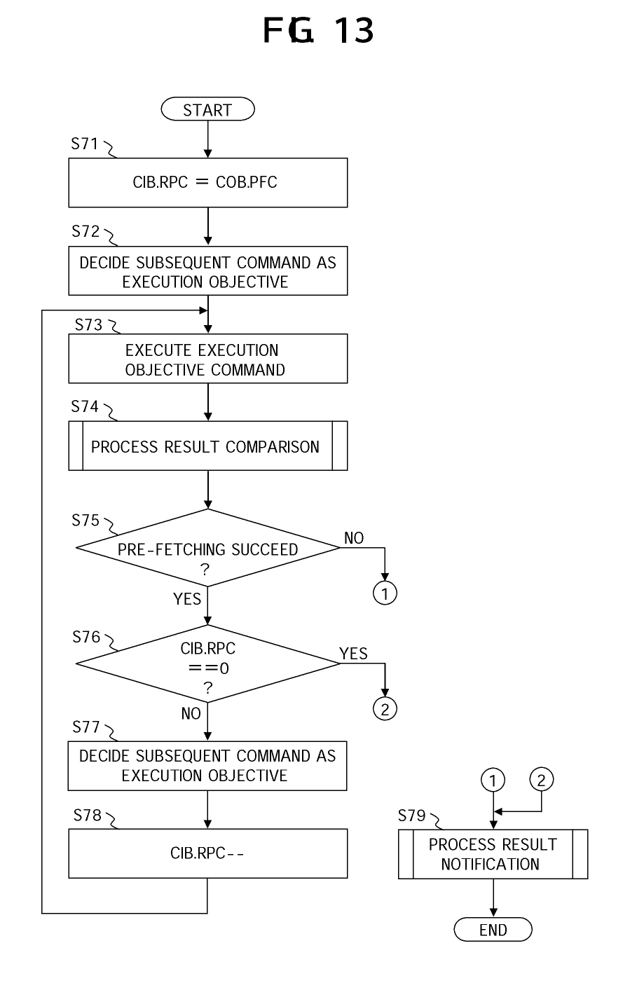

FIG. 13 illustrates a process executed by the CCW executing section 30.

In step 71, the PFC of the COB 70 is set to the RPC of the CIB 80.

In step 72, the command of next order is determined as the execution objective command among the commands set in the CIB 80.

In step 73, the command determined as the execution objective is executed.

In step 74, a sub-routine of a result comparing process is executed.

In step 75, it is judged whether or not the pre-fetching prediction succeeded. If the pre-fetching prediction succeeded (YES), the routine proceeds to step 76, whereas if the pre-fetching prediction failed (NO), the routine proceeds to step 79.

In step 76, it is judged whether or not the RPC of the CIB80 is 0. If the RPC is 0 (YES), the routine proceeds to step 79, whereas if the RPC is not 0 (NO), the routine proceeds to step 77.

In step 77, the command of next order is determined as the execution objective command among the commands set in the CIB 80.

In step 78, the RPC of the CIB 80 is decremented.

In step 79, a sub-routine of a result notifying process is executed.

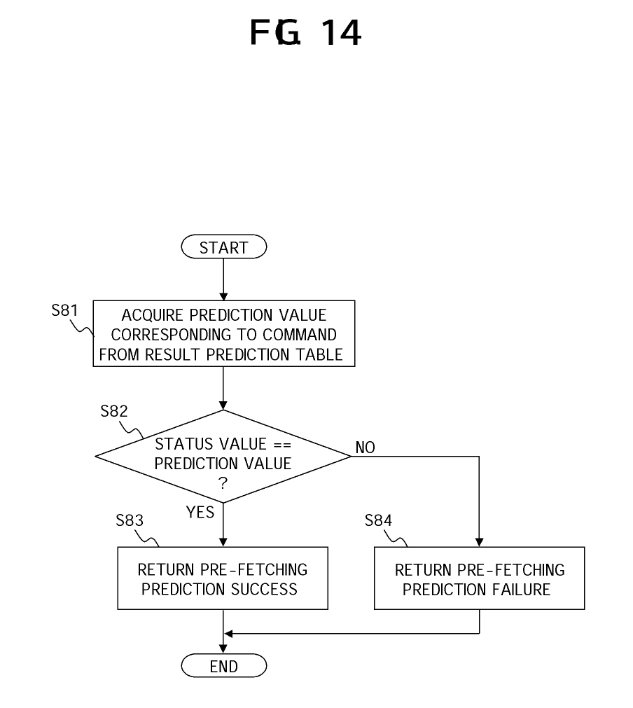

FIG. 14 illustrates a content of the sub-routine of the result comparing process executed in the result comparing section 30A.

In step 81, the prediction value corresponding to the lastly executed command is acquired from the table corresponding to the control objective input/output device among the result prediction tables 40.

In step 82, it is judged whether or not the actual status value returned from the input/output device as the command execution result is the same as the prediction value. If the status value is the same as the prediction value (YES), the routine proceeds to step 83, whereas if the actual status value is not the same as the prediction value (NO), the routine proceeds to step 84.

In step 83, information of pre-fetching prediction success is returned.

In step 84, information of pre-fetching prediction failure is returned.

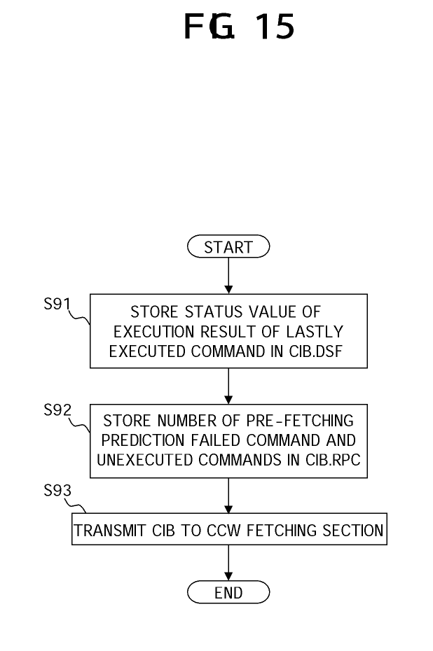

FIG. 15 illustrates a content of the sub-routine of the result notifying process executed in the result notifying section 30B.

In step 91, the actual status value returned from the input/output device as the execution result of the lastly executed command is stored in the DSF of the CIB 80.

In step 92, the number of pre-fetching prediction failed commands and the number of unexecuted commands due to the prediction failure are stored in the RPC of the CIB 80.

In step 93, the CIB 80 is transmitted to the CCW fetching section 20.

According to the CCW pre-fetching process of the present apparatus, following functions and effects are obtained.

Namely, in the CCW fetching section 20 (including the device discriminating section 20A, the result predicting section 20B and the result learning section 20C) that functions as a front end section of the CCW pre-fetching process of the present apparatus, when the pre-fetching of command is performed, the result prediction table 40 is referred to. Then, the status value to be returned from the input/output device is predicted as the predicted status value based on the prediction value of the status value of which prediction determining point is largest among the status values of the command execution results. Further, the pre-fetching of command is performed based on this prediction. On the other hand, in the CCW executing section 30 (including the result comparing section 30A and the result notifying section 30B) that functions as a back end section of the pre-fetching processing mechanism of the CCW program, the pre-fetched command is executed and the status value actually returned from the input/output device is fed back to the CCW fetching section 20. Then, in the CCW fetching section 20, when the prediction value is not coincident with the actual status value returned from the input/output device, it is judged that the prediction failed, and the prediction determining point of the result prediction table 40 is updated. Furthermore, in the result prediction table 40, when the prediction determining point corresponding to the received actual status value is larger than the prediction determining point corresponding to the status value set as the prediction value, the prediction value is updated by the received actual status value.

Thus, the content of the actual status value returned from the input/output device as the actual execution result is reflected in the result prediction table 40, and learned. Therefore, in the pre-fetching of command, it becomes possible to predict the status value of high probability of being received from the input/output device as the actual execution result, and therefore, the prediction precision can be improved. Further, it is possible to avoid mismatch between the pre-fetched command and the command to be next executed based on the actual status value from the input/output device, and therefore, the number of commands capable of being pre-fetched can be increased. As a result, it is possible to reduce communications traffic between the CCW fetching section 20 and the CCW executing section 30, and therefore, the input/output device can be efficiently controlled.

Further, in the process by the CCW fetching section 20, it is judged whether or not the address of the lastly fetched command is the same as the address of the command fetched just before the lastly fetched command. If both of the addresses are the same, the commands up to the command fetched just before the lastly fetched command are made to be the pre-fetching objectives. As a result, for example in the case where “TIC” which is the branch command exists and the command to be executed by “TIC” is the command fetched just before the lastly fetched command, it is possible to avoid an infinite loop due to the pre-fetching.

Furthermore, the result prediction tables 40 include the success count and the failure count for each control objective input/output device. Then, in the CCW fetching section 20, the pre-fetching is performed only when the success count are equal to or more than the failure count in the control objective input/output device. In the CCW fetching section 20, when the processes of the prior-fetched commands are all completed, the success count is incremented. On the other hand, when the pre-fetching failed, the failure count is incremented. According to such processes, in the case where there is used an input/output device which is not suitable for the pre-fetching since the prediction of the status value as the command execution result is difficult, it is possible to perform the control without necessity of performing the pre-fetching.

Still further, the result prediction tables 40 include the effective maximum number for each control objective input/output device. Then, in the CCW fetching section 20, the pre-fetching is performed within a range where the number of commands to be pre-fetched does not exceed the effective maximum number. According to such a process, it is possible to avoid an error due to that the pre-fetched commands exceed the data domain capable of being saved in the COB 70.

In the present apparatus, the result prediction table 40 is configured to include the prediction values, but no prediction value may be included if the result prediction table 40 includes the prediction determining point. In this case, to predict the status value as the command execution result in the CCW fetching section 20, the status value of which prediction determining point is largest is specified from the status values set in the result prediction table 40, and the specified status value may be made to be the prediction value.

Next, there will be described the CCW pre-fetching process in the present apparatus by illustrating specific examples for the case where the pre-fetching prediction succeeds and the case where the pre-fetching prediction fails.

In the present specific examples, the followings are assumed for both of the success case and the failure case.

“connection device: magnetic disk Z

CCW program being processing objective: 07-1F-23-31-TIC-06-1E-1E”

Process contents of commands of the CCW program are as follows.

07 (seek): moving read/write head to predetermined position

1F (set final mask): moving read/write head to a designated cylinder

23 (set sector): moving read/write head to a designated sector

31 (search ID): comparing a value of a count area of the position at the time from read/write head with a designated value

Depending on the comparison result, the status value is changed (coincidence: 4C, noncoincidence: 0C)

06 (read data portion): reading data domain from read/write head

1E (read count, key, data portion) reading count, key, data domain from read/write head

TIC: command for branching to arbitrary one word

[A. Case where the Pre-fetching Prediction Succeeds]

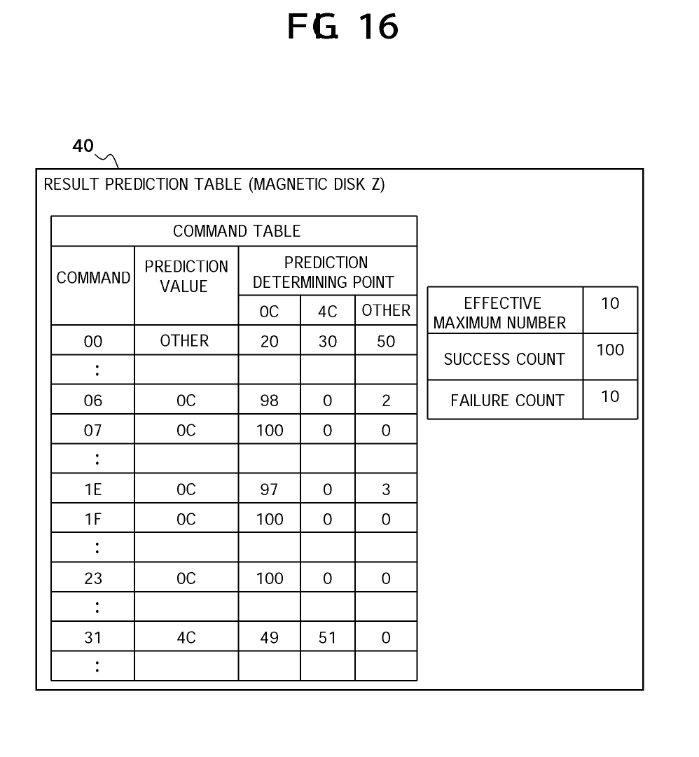

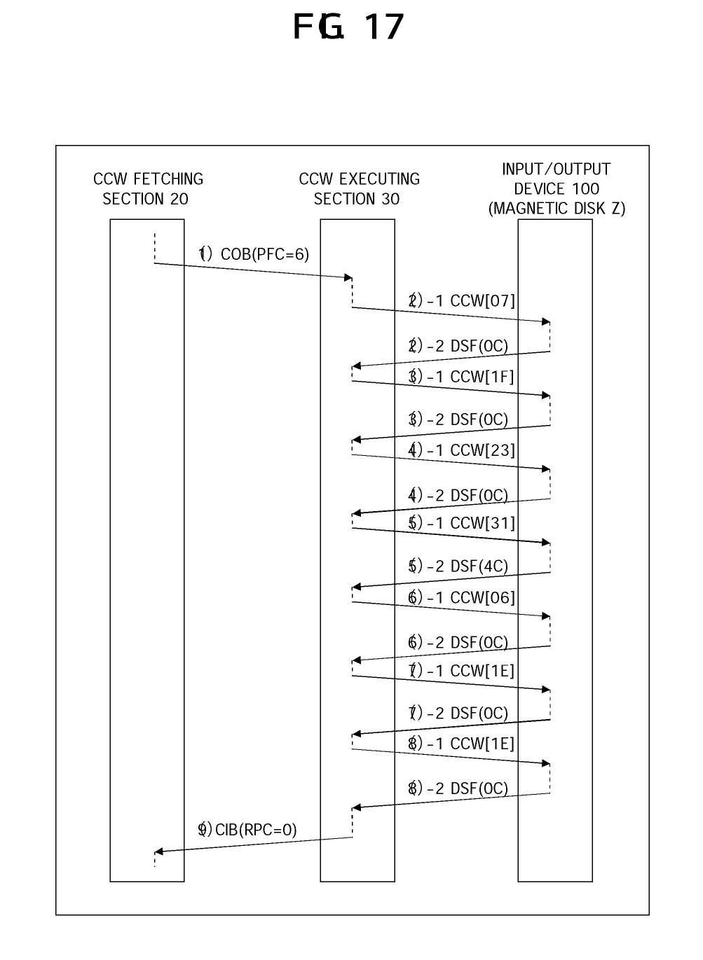

In this case, the table corresponding to the magnetic disk Z among the result prediction tables 40 is in a state illustrated in FIG. 16. Further, FIG. 17 illustrates a process sequence in the case where the pre-fetching prediction succeeds.

Firstly, in the CCW fetching section 20, the commands are pre-fetched, based on the prediction value of each command set in the table corresponding to the magnetic disk Z among the result prediction tables 40. As a result, the commands are pre-fetched as [07-1F-23-31-06-1E-1E], and set in the COB 70. Further, in the COB 70, “magnetic disk Z” is set as the input/output device name and “6” is set to the PFC.

(1) The CCW fetching section 20 transmits the COB 70 to the CCW executing section 30.

(2)-1 The CCW executing section 30 which has received the COB 70 executes the leading command [07] set in the COB 70.

(2)-2 The magnetic disk Z moves the read/write head according to the control by the execution of the command [07], and returns the status value “0C”.

(3)-1 The CCW executing section 30 executes the subsequent command [1F] set in the COB 70, since the status value “0C” is coincident with the prediction value “0C” in the result prediction table 40.

(3)-2 The magnetic disk Z moves the read/write head to the designated cylinder according to the control by the execution of the command [1F], and returns the status value “0C”.

(4)-1 The CCW executing section 30 executes the subsequent command [23] set in the COB 70, since the status value “0C” is coincident with the prediction value “0C” in the result prediction table 40.

(4)-2 The magnetic disk Z moves the read/write head to the designated sector area according to the control by the execution of the command [23], and returns the status value “0C”.

(5)-1 The CCW executing section 30 executes the subsequent command [31] set in the COB 70, since the status value “0C” is coincident with the prediction value “0C” in the result prediction table 40.

(5)-2 The magnetic disk Z acquires the designated value and a value of the sector counting area from the read/write head to verify that both of the values are coincident with each other, and returns the status value “0C”.

(6)-1 The CCW executing section 30 executes the subsequent command [06] set in the COB 70, since the status value “4C” is coincident with the prediction value “4C” in the result prediction table 40.

(6)-2 The magnetic disk Z reads out the data domain of the designated sector from the read/write head according to the control by the execution of the command [06], and returns the status value “0C”.

(7)-1 The CCW executing section 30 executes the subsequent command [1E] set in the COB 70, since the status value “0C” is coincident with the prediction value “0C” in the result prediction table 40.

(7)-2 The magnetic disk Z reads out the count, key, and data domain of the subsequent sector from the read/write head according to the control by the execution of the command [1E], and returns the status value “0C”.

(8)-1 The CCW executing section 30 executes the subsequent command [1E] set in the COB 70, since the status value “0C” is coincident with the prediction value “0C” in the result prediction table 40.

(8)-2 The magnetic disk Z reads out the count, key and data domain of the subsequent sector from the read/write head according to the control by the execution of the command [1E], and returns the status value “0C”.

(9) The CCW executing section 30 sets the status value “0C” as the execution result of the lastly executed command “1E” to the DSF of the CIB 80 and sets “0” indicating the success of pre-fetching to the RPC thereof, and then transmits the CIB 80 to the CCW fetching section 20. On the other hand, the CCW fetching section 20 increments the success count in the result prediction table 40 based on the value “0” of the RPC of the CIB 80.

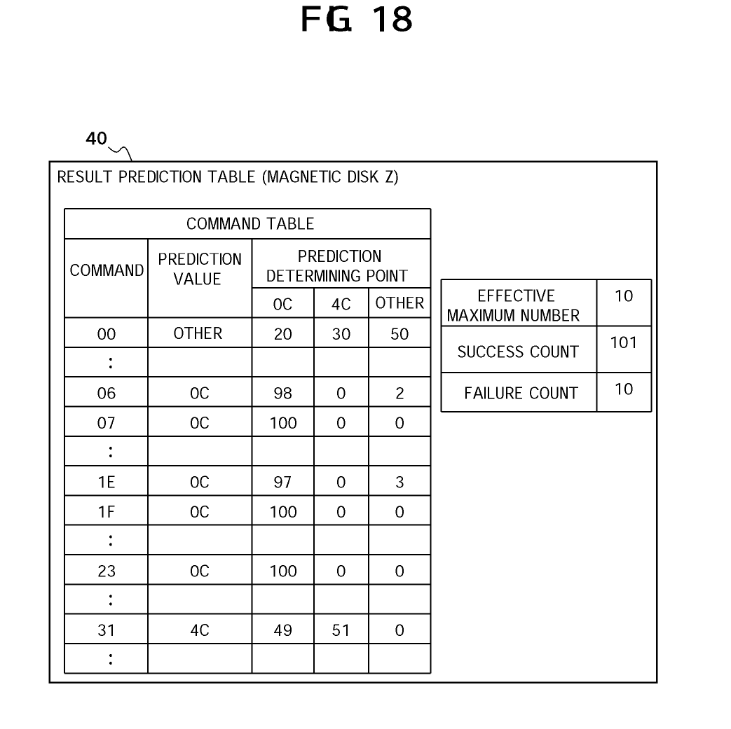

Then, in response to the execution of the above processes, the result prediction table corresponding to the magnetic disk Z is updated as illustrated in FIG. 18. Namely, the command table is not especially updated, but only the success count is incremented.

[B. Case where the Pre-fetching Fails]

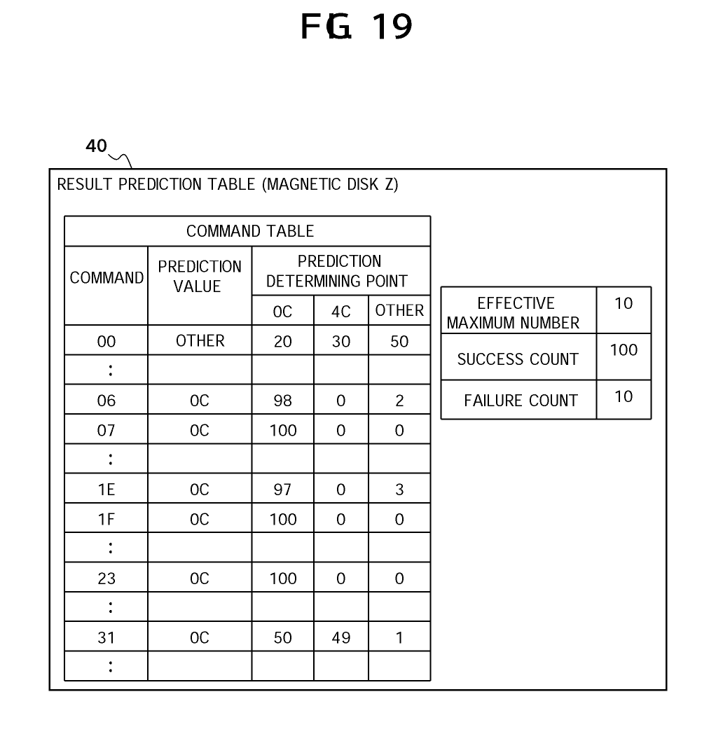

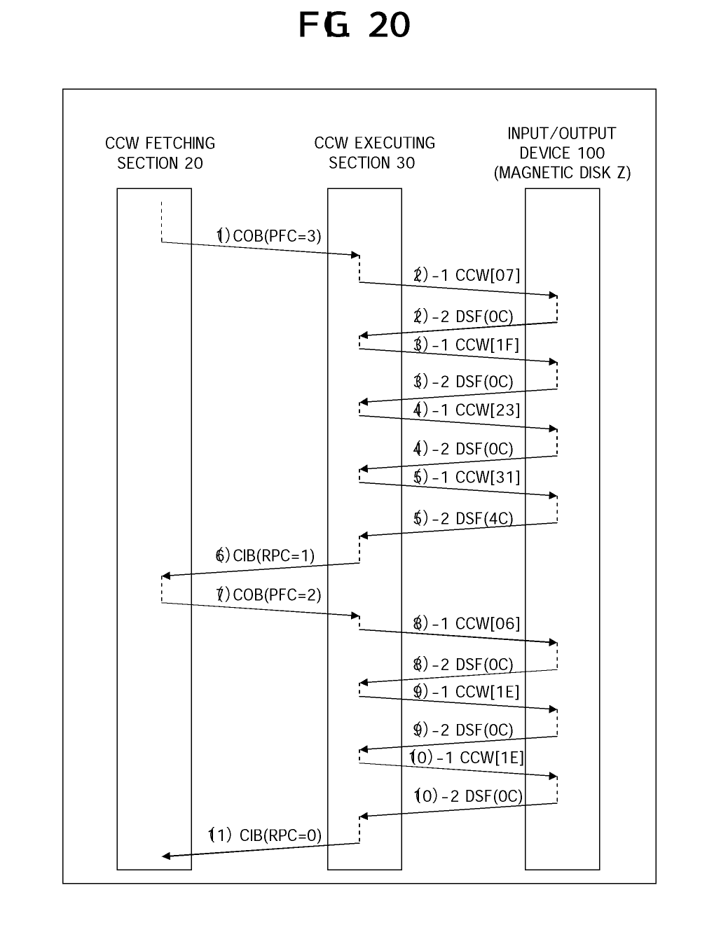

In this case, the table corresponding to the magnetic disk Z among the result prediction tables 40 is in a state illustrated in FIG. 19. Further, FIG. 20 illustrates a process sequence in the case where the pre-fetching prediction fails.

Firstly, in the CCW fetching section 20, the commands are pre-fetched, in the order based on the prediction value of each command set in the table corresponding to the magnetic disk Z among the result prediction tables 40. Here, in the result prediction table 40, since the prediction value of the command [31] is “0C” and the subsequent [TIC] designates the command having the address one address before, the address of the lastly fetched command becomes the same as the address of command fetched just before the lastly fetched command (refer to step 12). Therefore, the commands up to [07-1F-23-31] among the commands are pre-fetched and set in the COB 70. Further, in the COB 70, “magnetic disk Z” is set as the input/output device name and “3” is set to the PFC.

In (1) through (4), processes are executed similarly to (1) through (4) in the case where the pre-fetching succeeds as in the above A, and therefore, the description thereof is omitted.

(5)-1 The CCW executing section 30 executes the subsequent command [31] set in the COB 70, since the status value “0C” as the execution result of the command [23] in (4) is coincident with the prediction value “0C” in the result prediction table 40.

(5)-2 The magnetic disk Z acquires the designated value and a value of the sector counting area from the read/write head to verify that both of the values are coincident with each other, and returns the status value “4C”.

(6) The CCW executing section 30 sets the status value “4C” as the execution result of the lastly executed command [31] to the DSF of the CIB 80 and sets “1” to the RPC thereof, since the status value “4C” is not coincident with the prediction value “0C” in the result prediction table 40, and the CCW executing section 30 transmits the CIB 80 to the CCW fetching section 20.

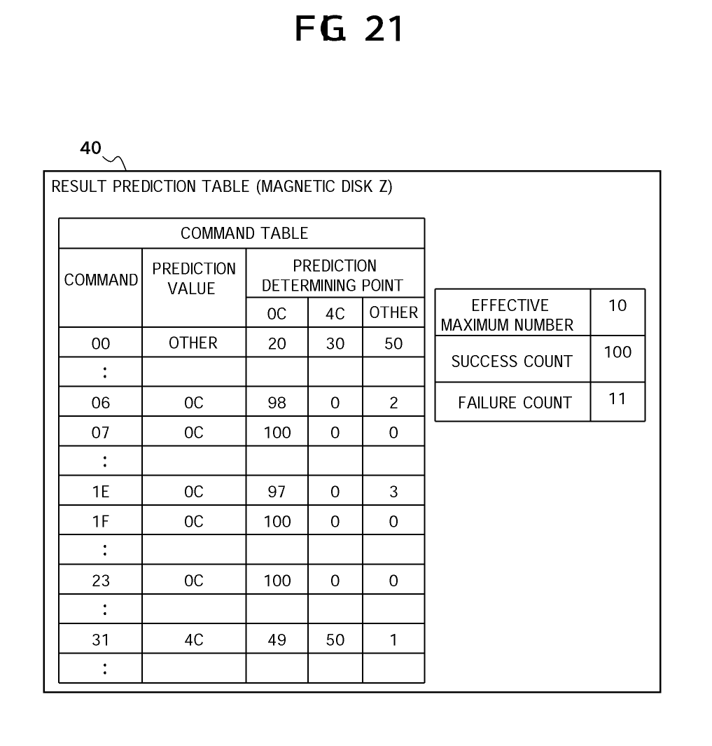

(7) In the CCW fetching section 20, following processes are executed. Namely, the result learning section 20C judges that the pre-fetching failed, based on the value “1” of the RPC, and decrements the point of the status value “0C” in the prediction determining point of the command [31] in the table corresponding to the magnetic disk Z among the result prediction tables 40, while incrementing the point of the status value “4C” thereof. Further, the result learning section 20C updates the prediction value to “4C”, since the maximum prediction determining point in the command [31] is changed from the prediction determining point of “0C” to that of “4C”. Furthermore, the result learning section 20C increments the failure count in the result prediction table 40. As a result, the result prediction table corresponding to the magnetic disk Z is updated as illustrated in FIG. 21.

Then, the CCW fetching section 20 restarts the pre-fetching from the subsequent command [06], to fetch the commands in the order based on the prediction value of each command set in the table corresponding to the magnetic disk Z. As a result, the commands [06-1E-1E] among the commands set in the table corresponding to the magnetic disk Z are pre-fetched and set in the COB 70. Further, in the COB 70, “magnetic disk Z” is set as the input/output device name and “2” is set to the PFC, to be transmitted to the CCW executing section 30.

(8)-1 The CCW executing section 30 which has received the COB 70 executes the leading command [06] set in the COB 70.

(8)-2 The magnetic disk Z reads out the data domain of the designated sector from the read/write head according to the control by the execution of the command

[06], and returns the status value “0C”.

In (9) and (10), processes are executed similarly to (7) and (8) in the case where the pre-fetching succeeds as in the above A, and therefore, the description thereof is omitted.

(11) The CCW executing section 30 sets the status value “0C” as the execution result of the lastly executed command [1E] to the DSF of the CIB 80 and sets “0” indicating the success of pre-fetching to the RPC thereof, and then transmits the CIB 80 to the CCW fetching section 20. On the other hand, the CCW fetching section 20 increments the success count in the result prediction table 40, based on the value “0” of the RPC of the CIB 80.

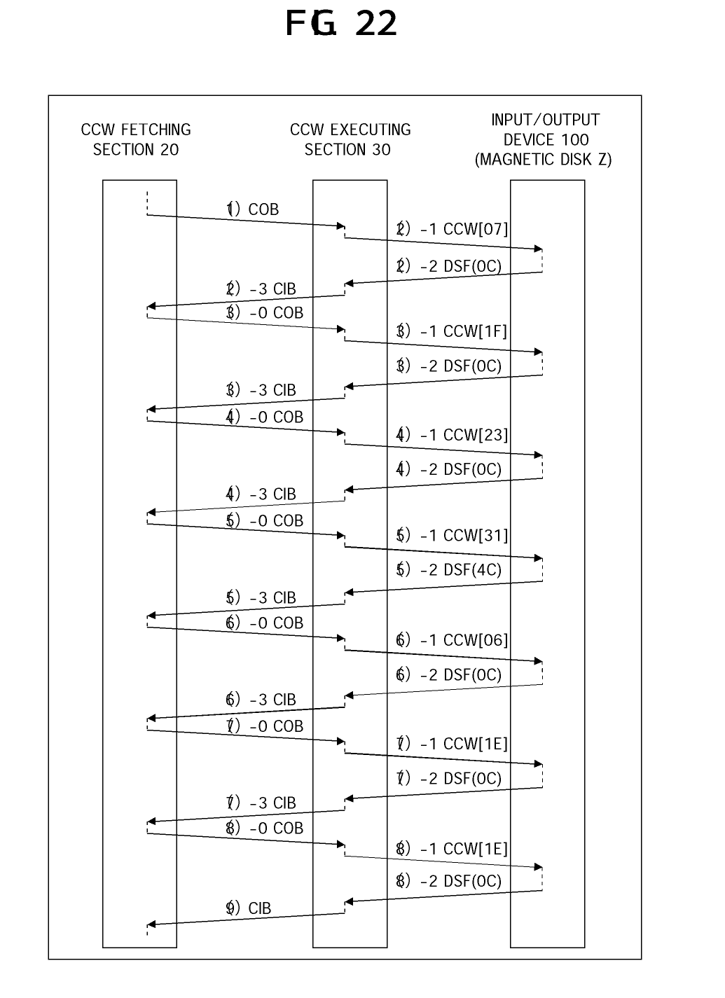

In the present specific examples, if the pre-fetching is never executed since [TIC] exists in the course of the CCW program, the process sequence thereof can be illustrated as in FIG. 22. In this case, following processes are repetitively executed for each command making up the CCW program. Namely, in the CCW fetching section 20, one of the commands in the CCW program is fetched and set in the COB 70, and then transmitted to the CCW executing section 30. Then, in the CCW executing section 30, the fetched command is executed, and the status value returned from the input/output device as the execution result is set in the CIB 80 and transmitted to the CCW fetching section 20. Further, in the CCW fetching section 20, one of the subsequent commands is fetched based on the transmitted status value.

The process sequence illustrated in FIG. 22 in the case where the fetching and execution are repetitively performed for each command without executing the pre-fetching is compared with the process sequence in FIG. 17 and FIG. 22. It is understood that the communications traffic between the CCW fetching section 20 and the CCW executing section 30 in the process sequence in FIG. 17 and FIG. 22 is significantly less than that in the process sequence in FIG. 22. Thus, by improving the pre-fetching precision to perform the pre-fetching, and by again fetching the commands only when the pre-fetching prediction and the actual status value are not coincident with each other, it is possible to significantly reduce data passing in the control of the input/output device 100, and also, to efficiently perform the control of the input/output device 100.

All examples and conditional language recited herein are intended for pedagogical purposes to aid the reader in understanding the principles of the invention and the concepts contributed by the inventor for furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer readable recording medium storing a CCW pre-fetching program causing a computer to execute a process comprising:
obtaining a predicted status value of each command execution result based on parameters by referring to a table in which the parameters are set for each input/output device being a control objective of a CCW program, the parameters indicating probability of being returned from the control objective input/output device for each status value to be returned from the control objective input/output device as an execution result of each command contained in the CCW program;
determining commands being pre-fetching objectives based on the predicted status value of each command execution result and pre-fetching all of the commands being the pre-fetching objectives from the CCW program stored in a memory;
sequentially executing the pre-fetched commands, when the pre-fetching of all of the commands being the pre-fetching objectives is completed;
receiving an actual status value of the command execution result from the control objective input/output device each time when the pre-fetched command is executed;
judging whether or not the received actual status value is the same as the predicted status value, when the actual status value is received; and
updating a value of the parameter which is set in the table and corresponds to the received actual status value, thereby being increased relatively to a value of the parameter which is set in the table and corresponds to the predicted status value, when it is judged that the received actual status value is different from the predicted status value.

2. A computer readable recording medium storing a CCW pre-fetching program according to claim 1,
wherein among the respective status values to be returned from the control objective input/output device as the execution results of the commands contained in the CCW program, a status value having the largest parameter value is further set in the table for each command, as a prediction value of highest probability of being returned from the input/output device, and
wherein the process of obtaining the predicted status value, comprises, referring to the prediction value of each command and obtaining the prediction value as the predicted status value of the execution result of each command.

3. A computer readable recording medium storing a CCW pre-fetching program according to claim 2, further comprising;
updating the prediction value by the received actual status value when the value of the parameter of the received actual status value is larger than the value of the parameter of the candidate status value set as the prediction value.

4. A computer readable recording medium storing a CCW pre-fetching program according to claim 1,
wherein the process of pre-fetching all of commands being pre-fetching objectives, comprises, in determining the commands being the pre-fetching objectives, if a branch command for branching to another command is contained in the commands of the CCW program and if the command to be executed by the branch command and the command fetched just before the branch command are coincident with each other, determining the commands up to the command fetched just before the branch command as the commands being the pre-fetching objectives, to perform the pre-fetching.

5. A computer readable recording medium storing a CCW pre-fetching program according to claim 1,
wherein, in the table, a success count indicating the number of prediction success times in the pre-fetching and a failure count indicating the number of prediction failure times in the pre-fetching are further set for each control objective input/output device, and
wherein the process of pre-fetching all of commands being pre-fetching objectives, comprises, performing the pre-fetching only when the success count is equal to or more than the failure count.

6. A computer readable recording medium storing a CCW pre-fetching program according to claim 5, further comprising;
updating the success count or the failure count such that the success count is added when the pre-fetched commands are all executed, whereas such that the failure count is added when it is judged that the received actual status value is different from the predicted status value.

7. A computer readable recording medium storing a CCW pre-fetching program according to claim 1,
wherein, in the table, an effective maximum number as an upper limit of the number of commands to be pre-fetched is set for each control objective input/output device, and
wherein the process of pre-fetching all of commands being pre-fetching objectives, comprises, performing the pre-fetching within a range where the number of commands to be pre-fetched does not exceed the effective maximum number.

8. A CCW pre-fetching processing apparatus, comprising:
predicting means for obtaining a predicted status value of each command execution result based on parameters by referring to a table in which the parameters are set for each input/output device being a control objective of a CCW program, the parameters indicating probability of being returned from the control objective input/output device for each status value to be returned from the control objective input/output device as an execution result of each command contained in the CCW program;
pre-fetching means for determining commands being pre-fetching objectives based on the predicted status value of each of the command execution result predicted by the predicting means and pre-fetching all of the commands being the pre-fetching objectives from the CCW program stored in a memory;
executing means for sequentially executing the pre-fetched commands, when the pre-fetching of all of the commands being the pre-fetching objectives is completed by the pre-fetching means;
receiving means for receiving an actual status value of the command execution result from the control objective input/output device each time when the pre-fetched command is executed by the executing means;
judging means for judging whether or not the received actual status value is the same as the predicted status value predicted by the predicting means, when the actual status value is received by the receiving means; and
first updating means for updating a value of the parameter which is set in the table and corresponds to the received actual status value, thereby being increased relatively to a value of the parameter which is set in the table and corresponds to the predicted status value, when it is judged by the judging means that the received actual status value is different from the predicted status value.
